(19) United States
(12) Patent Application Publication
(10) Pub. No.: US 2025/0246975 A1
(43) Pub. Date: Jul. 31, 2025

(54) Electric Motor

(71) Applicant: Innomotics GmbH, Nürnberg (DE)

(72) Inventor: Frank Brütting, Erlangen (DE)

(73) Assignee: Innomotics GmbH, Nürnberg (DE)

(21) Appl. No.: 18/880,858

(22) PCT Filed: Jun. 13, 2023
(86) PCT No.: PCT/EP2023/065726

§ 371 Date: Jan. 3, 2025

(30) Foreign Application Priority Data
Jul. 5, 2022 (EP) 22182976.5

(51) Int. Cl. H02K 11/33; H02K 9/22

(52) U.S. Cl. CPC H02K 11/33; H02K 9/22; H02K 2203/03; H02K 2211/03

(57) ABSTRACT

Various embodiments of the teachings herein include an electric motor comprising: a stator having a plurality of field conductor bars; an inverter having parallel power components for each of the field conductor bars for the actuation thereof, wherein the inverter comprises a controller to generate actuation signals for the power components; at least one plug-in connector arranged on each of the circuit boards to contact the end stages; and a connecting PCB plugged onto the plug-in connectors of at least two of the circuit boards of one of the circular or annular structures. End stages of the inverter are arranged on a plurality of circuit boards. The circuit boards are arranged to form one or several circular or annular structures;

### CROSS-REFERENCE TO RELATED APPLICATIONS

This application is a U.S. National Stage Application of International Application No. PCT/EP2023/065726 filed Jun. 13, 2023, which designates the United States of America, and claims priority to EP application Ser. No. 22182976.5 filed Jul. 5, 2022, the contents of which are hereby incorporated by reference in their entirety.

### TECHNICAL FIELD

The present disclosure relates to an electric motor with a stator-side bar winding.

### BACKGROUND

Electric motors can have a bar winding on the stator side. Here, the stator has a row of bars instead of wound wire conductors as field conductors. The bars have a low inductance in comparison with conventional windings. A comparatively higher current flow is therefore required to generate a specified magnetic field.

However, on account of the low inductance of the bars, this high current flow requires only a comparatively low voltage of 12 V, for example. The low voltage makes it possible to arrange the components of the inverters used to actuate the bars at smaller distances relative to one another. The components of the power electronics can thus be arranged for example on one or more PCBS, which are arranged close to the electric motor.

It may be advantageous to provide an electric motor in a compact manner such that each of the field conductors is actuated by separate power components and thus each field conductor can be actuated with a separate phase. Electric motors can thus be configured in a compact manner with 48, 72 or also 120 field conductors and phases. It may be problematic, however, that the large number of power components must be connected to a central controller. Cable connections between a central controller and a multiplicity of power components may result in a highly complex configuration.

### SUMMARY

The teachings of the present disclosure include electric motors which eliminate the disadvantage cited herein, in particular having an efficient connection between controller and power components. For example, some embodiments include an electric motor (10) with: a stator (11) having a plurality of field conductors (12) embodied as bars, an inverter having one or several parallel power components for each of the field conductors (12) for the actuation thereof, wherein the inverter comprises a controller for generating actuation signals for the power components, wherein the end stages of the inverter are arranged on a plurality of circuit boards (15), the circuit boards (15) are arranged such that they embody one or several circular or annular structures, one or several plug-in connectors (33) are arranged on each of the circuit boards (15) for contacting the end stages, a connecting PCB (32, 61, 75) is plugged onto the plug-in connectors (33) of at least two of the circuit boards (15) of one of the circular or annular structures.

In some embodiments, the connecting PCB (32, 61, 75) is plugged onto the plug-in connectors (33) of all circuit boards (15) of a circular or annular structure.

In some embodiments, the connecting PCB (32, 61, 75) is annular or ring-sector-shaped.

In some embodiments, the circuit boards (15) embody two or more circular or annular structures and for each of the circular or annular structures a connecting PCB (32, 61, 75) is plugged onto the plug-in connectors (33) of at least two circuit boards (15) of each of the circular or annular structures.

In some embodiments, the circular or annular structures are arranged parallel to one another and offset axially with respect to one another such that their center points lie on a common central axis.

In some embodiments, the axis of the circular or annular structures corresponds to the motor axis (9).

In some embodiments, the circular or annular structures have the same diameter.

In some embodiments, the connecting PCB (32, 61, 75) is arranged parallel to the plugged-on circular or annular structure.

In some embodiments, the connecting PCB (32, 61, 75) comprises gate driver circuits (72) for the end stages of the plugged-on circular or annular structure.

In some embodiments, the connecting PCB (32, 61, 75) comprises a multiplexer (93) and is embodied to conduct a control signal arriving from the controller to one of several signal lines in such a manner that said control signal is conducted to the power component to which the control signal applies.

In some embodiments, the connecting PCB (32, 61, 75) comprises one or several screwed connections to the circular or annular structure.

In some embodiments, the circuit boards (15) are arranged on at least one cooling plate (16) and in which the cooling plate (16) is arranged such that the field conductors (12) or current conductors (18) electrically connected to the field conductors (12) have an active mechanical connection with the cooling plate, in particular are embodied as mechanical carriers for the cooling plate (16).

In some embodiments, the circuit boards (15) are embodied in the shape of a circle sector or ring sector.

In some embodiments, electric motor (10) actuates the field conductors (12) with at least 6 phases.

In some embodiments, the inverters are embodied to generate an alternating voltage with an amplitude of 100 V or less, in particular 50 V or less, in particular 20 V or less.

### BRIEF DESCRIPTION OF THE DRAWINGS

The teachings of the present disclosure are described and explained in greater detail making reference to the exemplary embodiments illustrated in the drawings. In schematic form:

FIG. 1 shows an oblique view of an electric motor incorporating teachings of the present disclosure with power components arranged on circuit boards carried on cooling plates;

FIG. 2 shows a front view of PCBs arranged on a cooling plate;

FIG. 3 shows an oblique view of a section of the electric motor with cooling plates having circuit boards;

FIG. 4 shows a side view of a section of the electric motor with cooling plates having PCBs and connecting PCBs plugged on by way of spring contacts;

FIGS. 5 to 7 show a front view of the electric motor with cooling plates having circuit boards and connecting PCBs; and

FIG. 8 shows a sectional image of a cooling plate with circuit board, driver PCB and connecting PCB.

### DETAILED DESCRIPTION

An example electric motor incorporating teachings of the present disclosure comprises a stator with a plurality of field conductors embodied as bars. The electric motor further comprises an inverter with one or several parallel power components for each of the field conductors for the actuation thereof, wherein the inverter comprises a controller for generating actuation signals for the power components. Here, the end stages of the inverter are arranged on a plurality of circuit boards. The circuit boards are in turn arranged such that they embody at least one circular or annular structure.

One or several plug-in connectors are arranged on each of the circuit boards for contacting the end stages. A connecting PCB is plugged onto the plug-in connectors of at least two of the circuit boards of one of the circular or annular structures.

Because the circular or annular structures are made up of a plurality of circuit boards, they are not geometrically exact and neither does the circular or annular area need to be completely filled. On the contrary, gaps remain between the circuit boards.

The plug-in connectors can be, for example, spring contacts or direct PCB plug-in connectors. A socket or an (integrated) connector or a screw contact can be involved here, wherein the corresponding opposite side is arranged on the connecting PCB.

In this disclosure, an end stage means essentially the power semiconductor switches associated with an alternating voltage output. Because the gate driver circuits associated with the power semiconductor switches are spatially separate from the power semiconductor switches in some embodiments, said gate driver circuits are not included in the end stage. A power component is understood to mean the power semiconductor switches together with their respective gate driver circuits. The totality of power components and controller is referred to as the inverter.

The teachings herein make it possible to achieve a particularly simple type of contacting of the electronic components on the circuit boards, in which a multiplicity of cables between the controller and the circuit boards is replaced by a single connecting PCB for each circular or annular structure. If such an electric motor has for example 72 phases, in other words 72 field conductors, and if every three of these field conductors are actuated by one circuit board, then each circular or annular structure comprises 24 circuit boards. Instead of 24 cables to the controller, the connecting PCB is used, which is expediently connected to the plug-in connectors of all circuit boards. Said connecting PCB can be connected to the controller with a single cable. In some embodiments, a connecting PCB, in particular exactly one connecting PCB, is present for each circular or annular structure.

The connecting PCBs establish an indirect connection between the controller on the one hand and the end stages, in other words the power semiconductor switches, on the circuit boards on the other hand. Indirectly in this context means that the gate driver circuits for the power semiconductor switches are disposed in the middle of this connection. The gate driver circuits can be arranged in different ways.

In some embodiments, the connecting PCB is circular or annular. In the case of the connecting PCB as well as the annular structures, the circular shape leaves a recess in the center, through which air cooling can be realized.

In some embodiments, the connecting PCB is plugged onto the plug-in connectors of all circuit boards of a respective circular or annular structure. It then connects all circuit boards of the circular or annular structure to the controller and reduces as far as possible the number of necessary cable connections.

In some embodiments, the connecting PCB is ring-sector-shaped. In other words, the connecting PCB forms only a ring section. In this case, moreover, it is only plugged onto one part of the circuit boards of a circular or annular structure. Here, a plurality of identical connecting PCBs cover the entire ring in such a manner that all circuit boards are plugged onto one of the connecting PCBs. In the case of smaller electric motors, the central angle can be approximately 180°, 120° or 90°, wherein 2, 3 or 4 connecting PCBs are then required for contacting all circuit boards of a circular or annular structure.

In the case of large electric motors with many phases, the diameter of the circular or annular structures can lie in the meter range. In this case, it can be expedient to use significantly smaller central angles, as otherwise the connecting PCBs would become too large. In this case, the connecting PCBs can be designed such that they contact for example two, three or four of the circuit boards. In the case of an electric motor with 120 phases, in which the connecting PCB contacts three of the circuit boards, the central angle measures only approximately 9°. With such connecting PCBs, the curvature of the circumference is slight and a rectangular PCB can also be used instead of a ring-sector-shaped connecting PCB. Because it may be advantageous for the circuit boards all to be designed identically, the positioning of the plug-in connectors may nevertheless correspond to an annular arrangement.

The specifications regarding the central angle do not need to be exact. The actual central angles can in particular be somewhat smaller, as this still leaves some space between the connecting PCBs and all circuit boards can nevertheless be contacted. Although such connecting PCBs give rise to an increased number of cables to the controller in comparison with an annular connecting PCB, they are however significantly easier to attach and remove, above all if the electric motor comprises a plurality of cooling plates equipped on both sides with circuit boards.

In some embodiments, the number of connecting PCBs corresponds to the number of circular or annular structures. If the circuit boards embody two or more circular or annular structures, then for each of the circular or annular structures a connecting PCB is plugged onto the plug-in connectors of at least two circuit boards of each of the circular or annular structures.

In some embodiments, the connecting PCB is connected to a plurality of circuit boards of two different circular or annular structures, wherein these structures are then arranged on two adjacent cooling plates on sides facing toward one another. Here, the connecting PCB is plugged onto the circuit boards of one of the two circular or annular structures by means of plug-in connectors. The connecting PCB can furthermore also be plugged onto the circuit boards of the other circular or annular structures by means of plug-in connectors. In some embodiments, the connection can however also be realized by means of cable connections so as to be able to maintain a more flexible distance with respect to one of the two circular or annular structures and to simplify installation. This embodiment can be combined with other embodiments. For example, two concentric and coplanar connecting PCBs can be present and plugged onto the circuit boards of two circular or annular structures facing toward one another in order to provide actuation redundancy. The connecting PCBs can also be complete rings or ring-sector-shaped connecting PCBs or such having a different shape.

Even if the connecting PCBs are completely annular, the electric motor can comprise two or more of the connecting PCBs for each of the circular or annular structures. Said connecting PCBs can have for example different radii and thus be plugged onto the circular or annular structure in a concentric and coplanar manner.

In some embodiments, the connecting PCBs are only ring-sector-shaped. In this case, connecting PCBs with different radii can be plugged onto the circular or annular structure in a concentric and coplanar manner and thus embody two incomplete rings. In both cases cited, the connecting PCBs and circuit boards can be embodied such that each of the circuit boards is plugged onto exactly one of the connecting PCBs. In this case, an inner ring can for example contact every second one of the circuit boards or every second one of the phases, and an outer ring the remaining circuit boards or phases. In this case, the connecting PCBs thus cover all circuit boards but contact only every second one thereof.

In some embodiments, each of the circuit boards is plugged onto two or more connecting PCBs. Here, the connecting PCBs thus contact all covered circuit boards. This makes it possible to create a redundancy and to avoid the failure of the entire motor or a large part thereof in the event of a failure of a connecting PCB.

In some embodiments, the central axis of the circular or annular structure or structures can correspond to the motor axis. This means in other words that the center of each circular or annular structure lies on the motor axis and that each of the circular or annular structures is arranged at right angles to the motor axis.

If the electric motor has several circular or annular structures, then these may be arranged parallel to one another and offset axially with respect to one another such that their center points lie on a common central axis.

In some embodiments, the connecting PCB is arranged parallel to the plugged-on circular or annular structure, in other words at right angles to the central axis, in particular at right angles to the motor axis.

In this form of arrangement of the circular or annular structures, the field conductors or the current conductors as a linear continuation thereof penetrate the circular or annular structures in a rotationally symmetric manner. This results in a configuration which lends itself well to modularization, in which identical PCBs can be used and in which the contacting of a respective field conductor is particularly simple.

In some embodiments, the field conductors or the current conductors as a continuation thereof can even act as mechanical carriers for the PCBs, as a result of which the configuration is simplified further.

In some embodiments, the connecting PCB can comprise gate driver circuits for the power components. As a result, the gate driver circuits no longer take up separate space on the PCBs. Correspondingly more space remains on the PCBs for the power components, which simplifies the design of the PCBs. Furthermore, waste heat arising from the gate driver circuits is also removed from the PCBs and cooling is thus simplified.

Furthermore, the connecting PCB can also comprise one or several local control chips which perform control tasks, for example current measurement for a respective end stage. The local control chips are assigned in each case to one or several gate driver circuits and are connected thereto.

In some embodiments, the gate driver circuits can be arranged on the PCBs themselves together with the respective power semiconductor switches. This makes the connecting PCBs simpler in terms of configuration, as they merely have to establish a connection between the controller and the PCBs and thus the gate driver circuits. The connecting PCBs can advantageously comprise a multiplexer for this purpose.

In some embodiments, the gate driver circuits can also be arranged on separate driver PCBs. These may be plugged onto the PCBs with the power semiconductor switches, wherein the PCBs are in this case arranged in the manner of a sandwich, in other words with the driver PCBs at least partially covering the PCBs. In this case, the connecting PCBs can be plugged onto the driver PCBs or onto the circuit boards, in other words having a connection to one of the PCB types via which the signals are transferred.

Each phase which is actuated on a PCB has for this purpose a half-bridge, which is made up of two logical switches. Here, a logical switch can comprise exactly one single power semiconductor switch. To enable higher currents to be switched, a logical switch can however also comprise a plurality of power semiconductor switches, for example two, three, five or even more power semiconductor switches, which are connected in parallel.

In some embodiments, a gate driver circuit is designed such that it actuates the control connections (for example gate connections) of the two logical switches of the half-bridge, in other words supplies current/voltage in such a manner that the switching operations required by the controller take place and the switches are switched on and switched off in a manner required by the controller.

If the logical switches of the half-bridge comprise in each case more than one parallel power semiconductor switch, then the gate driver circuit can be embodied to actuate all of the power semiconductor switches. It is however also possible to provide more than one gate driver circuit for actuation purposes. For example, the number of gate driver circuits can correspond exactly to the number of parallel power semiconductor switches. If the half-bridge comprises five high-side MOSFETs and five low-side MOSFETs, up to ten gate driver circuits can therefore be present for this purpose. In this case, it is advantageous for space reasons to arrange the gate driver circuits on the driver PCB or on the connecting PCB.

The connecting PCB can comprise a multiplexer and further additional circuits such as for example monitoring, actuation, amplifier/buffer circuits or communication interfaces, and can be embodied such that a control signal arriving from the controller on a first signal line for a first power component is conducted by way of the multiplexer to one of several second signal lines, which is connected to the first power component for example via a spring contact.

As a result of the multiplexer on the connecting PCB, the controller must only be connected with a single signal line to the connecting PCB, which simplifies the configuration. In some embodiments, the connecting PCB connects several power components on a single PCB as well as a plurality of power components connected in parallel to the controller, as in this case without the multiplexer a large number of parallel control lines would be required from the controller to the connecting PCB. Here, the single signal line can be a direct electrical line or also a connection working according to a communication standard, such as for example a USB connection, a LAN connection, an optical connection or a screw connection.

In some embodiments, the connecting PCB can comprise one or several screw connections with one or several of the circular or annular structures. Using screw connections prevents the connecting PCB from working loose on account of vibrations or other external circumstances.

In some embodiments, the connecting PCB can be a flexible circuit board. Flexible circuit boards can become deformed as a result of mechanical stress. Here, conductor paths and other electronic components on such circuit boards retain their electrical function.

In some embodiments, the current conductors can be designed such that they extend the field conductors axially. Here, the current conductors are designed in a similar manner to the field conductors of the electric motors but can for example have a different cross-sectional shape. For example, the current conductors can have a round cross-section while the field conductors have an elongated rectangular cross-section. It is expedient if the current conductors can carry at least the same current as the field conductors. Current conductors and field conductors can be connected by way of lugs, embodied for this purpose, which ensure a mechanical and electrical connection.

The circuit boards can be arranged on at least one cooling plate. Here, the cooling plate can be equipped on both sides with the PCBs to achieve a high density of the electrical components. The cooling plate may comprise a metal, essentially circular or annular plate. Here, the cooling plate can have heat pipes for dissipating heat or cooling channels for air to flow through. The cooling plate can also be made up of two annular plates arranged in parallel, which are screwed together such that a space remains therebetween. An active ventilation can then be arranged such that air is drawn in between the plates.

The cooling plate can be arranged such that the field conductors or current conductors connected electrically to the field conductors have an active mechanical connection with the cooling plate. For example, the current conductors or field conductors can be embodied as mechanical carriers for the cooling plate. For this purpose, the cooling plate is preferably arranged at right angles to the axis of the electric machine. In this way, the cooling plate can be arranged with the circuit boards in a space-saving manner at an axial end of the electric machine.

In some embodiments, the circuit boards can be embodied in the shape of a circle sector or ring sector. Circuit boards with this shape lend themselves particularly well to being fitted together to form a circle or ring and can thus be arranged at an axial end of the machine in such a manner that they are optimally adjusted to the shape of the electric machine, wherein at the same time a high degree of modularity is achieved.

In some embodiments, the power components generate an alternating voltage with an amplitude of 200 V or less, in particular 100 V or less, in particular 50 V or less. Only then is it made possible for the components of the power electronics, in particular the power semiconductor switches, to be arranged at small distances apart from one another in the millimeter range and thus for a significant number of power semiconductor switches to be arranged on a relatively small space. This makes it possible to provide high currents without an excessively large space requirement and at the same time to generate a multiplicity of phases, for example 6, 12, 24, 48, 72 or even 120 phases.

In some embodiments, the field conductor bars can be solid bars, for example made from copper, but in other embodiments of the electric motor can also have subdivisions in the longitudinal direction or be designed as conductor bundles, wherein the general structure as a bar (instead of as a winding) is retained.

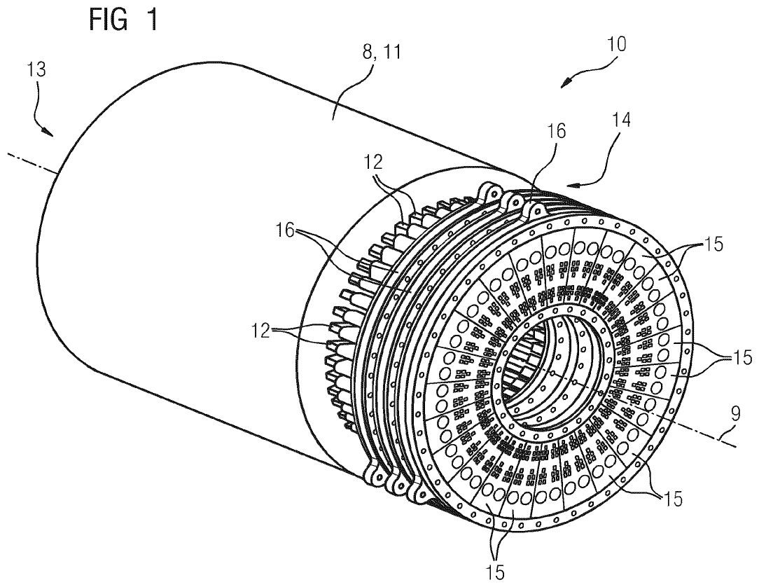

FIG. 1 represents an isometric view of an electric motor 10 incorporating teachings of the present disclosure. The electric motor 10 comprises a stator 11 and a rotor (not visible in FIG. 1) arranged substantially in the stator 11. The rotor is connected in a torsion-resistant manner to a shaft, which is likewise not shown in FIG. 1. The electromagnetic interaction of the rotor with the energized stator 11 causes the rotor to rotate about an axis 9. Here, the rotor is separated from the stator 11 by an air gap. In other embodiments, the electric motor 10 can also be an external-rotor motor or a bell-type armature motor.

The stator 11 comprises a plurality of rigid and straight conductor bars 12 as field conductors. These conductor bars 12 are connected to one another via a short-circuit ring on the end face 13 facing away in FIG. 1. On the rear side 14 of the electric motor 10, the conductor bars 12 are supplied individually by associated inverter modules in each case. Because the electric motor 10 is operated at low voltages on account of the conductor bars 12, the inverter modules can be arranged relatively closely together with other components of the electronics (DC voltage converters, rectifiers) on circuit boards 15. The circuit boards 15 in this example are ring-sector-shaped and many individual circuit boards 15 together embody an annular PCB structure.

While it is assumed in the examples that the circuit boards 15 carry at least the power components of inverters, it is also possible for a part of the circuit boards 15 to carry rectifiers and DC/DC converters.

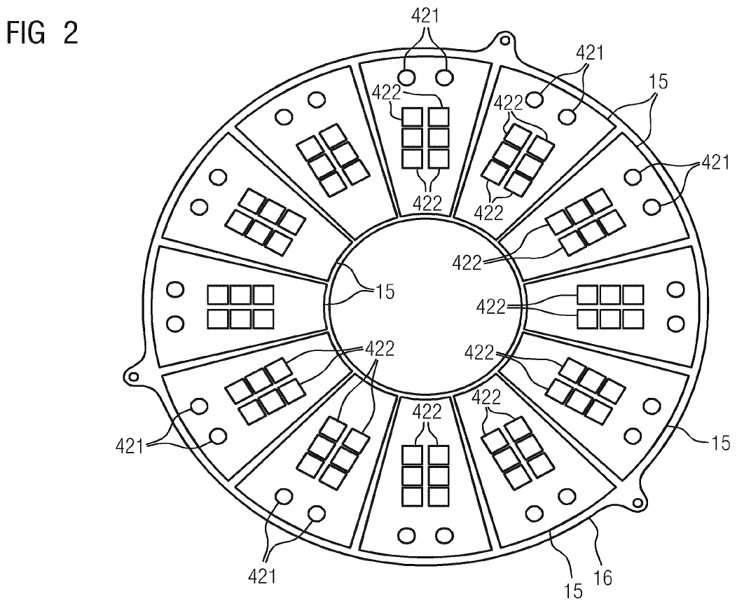

FIG. 2 shows a top view of such a PCB structure. For greater clarity compared to the representation in FIG. 1, the number of PCBs shown in FIG. 2 is reduced and shown in a highly simplified representation. The specific number of such circuit boards 15 depends on the specific embodiment of the electric motor 10, in particular the number of conductor bars 12. Each of the circuit boards 15 comprises several semiconductor switches 422. The semiconductor switches 422 together embody power components of inverters, which provide an alternating voltage for the conductor bars 12.

In some embodiments, a part of the circuit boards 15 or all circuit boards 15 can comprise driver circuits and other electronic components such as capacitors (not shown in the figures). The semiconductor switches 422 are power semiconductors, such as for example IGBTs, MOSFETs or JFETs, and can additionally comprise diodes (not shown), depending on the circuit arrangement. The semiconductor switches 422 are connected for example as half-bridges. A capacitor (not shown) can represent for example an intermediate circuit capacitor of the half-bridges. Here, the semiconductor switches 422 of a circuit board 15 can be assigned to an individual phase. In the case of an electric motor 10 with a large number of field conductors 12 and a corresponding number of phases, it may be advantageous if a circuit board 15 carries the power components for several phases.

The circuit boards 15 also comprise contact points 421, to which the conductor bars 12 are connected. The circuit boards 15 are carried by disk-shaped cooling plates 16, wherein the cooling plates 16 can be equipped on both sides with circuit boards 15 for better space utilization.

As relatively high currents are required in the conductor bars for the electric motor 10, several power components may be connected in parallel for the application of current thereto. This can be achieved for example by the six PCB structures shown in FIG. 1 on three cooling plates 16 all being connected in the same manner to the conductor bars 12 and thus being connected electrically in parallel. Here, use is made of the fact that the conductor bars 12 or connecting elements 18 to the conductor bars 12 penetrate the cooling plates 16 and thus also the circuit boards 15 in the same manner at the contact points or, in the case of the outermost cooling plate 16, at least make contact therewith.

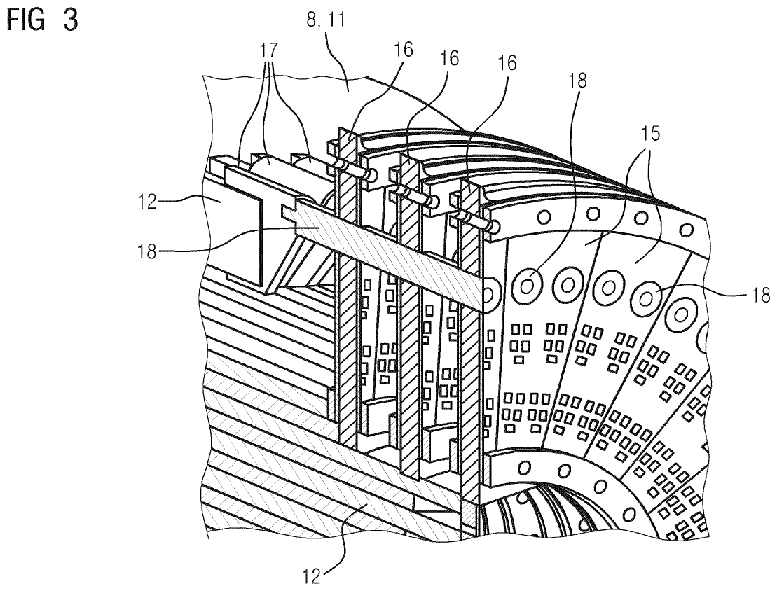

FIG. 3 shows a sectional image of the electric motor 10 in an oblique view. Here, it can be seen that the connecting elements 18 carry the three cooling plates 16 mechanically and penetrate the same. The connecting elements 18 are connected to the conductor bars 12 via lugs 17. The end stages, which lie in the regions on the circuit boards 15 in which one of the connecting elements 18 penetrates a cooling plate 16, are connected in parallel and together provide the current for the conductor bar 12. In the configuration shown in FIG. 3, it can be seen that two of the connecting elements 18 in each case run through a PCB 15. Each of the PCBs thus carries the end stages for two phases of the electric motor 10. In other variants for the electric motor 10, a single circuit board 15 can also carry only one phase or three or more phases, wherein the same number of connecting elements 18 runs through the circuit board 15.

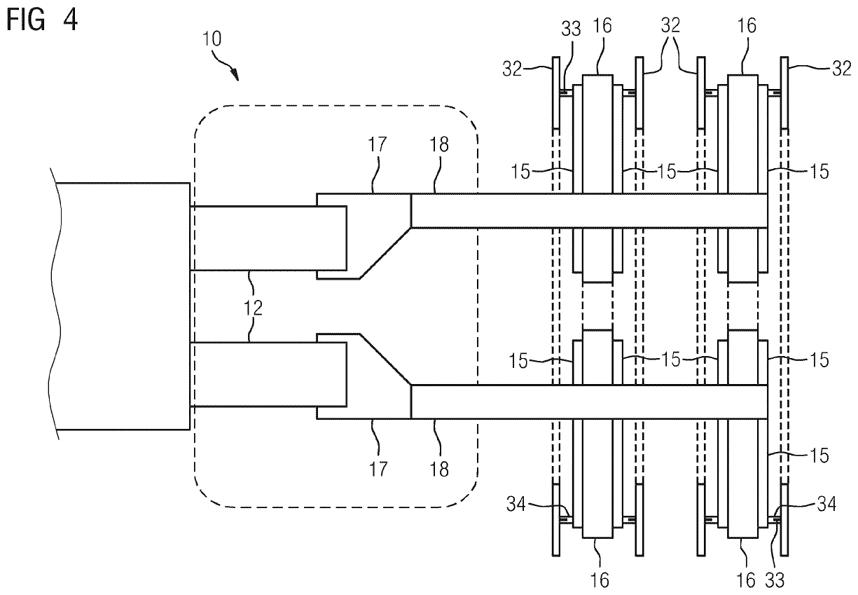

FIG. 4 shows a side view of a section of the electric motor 10. Eight circuit boards 15 are shown in FIG. 4, which are arranged on two cooling plates 16. FIG. 4 also shows four connecting PCBs 32, which in each case connect two of the circuit boards 15. The connecting PCBs 32 are connected in parallel with the circuit boards by means of spring contacts 33 to sockets 34 of a respective circuit board 15. Each of the connecting PCBs 32 also has a socket 35.

The socket 35 is provided for a cable connection 36 with the controller. It can guide the signal lines out in parallel, for example as a multipoint socket for a direct PCB plug-in connector or as a socket for a parallel interface cable. A further possibility consists in that the socket 35 is a USB or LAN (RJ45) socket. Other connection types, such as optical connections, are also conceivable. The connecting PCB 32, 61 can also have electronic components (not shown), for example for actuating the socket 35 or for other signal preparation, signal processing or communication purposes.

The arrangement in FIG. 4 corresponds to those of FIGS. 1 to 3. Of the annular structure formed by the circuit boards 15, the sectional image of FIG. 4 therefore includes exactly eight circuit boards 15. The connecting PCBs 32 shown in FIG. 4 are annular and are also plugged onto the circuit boards 15 which are not shown.

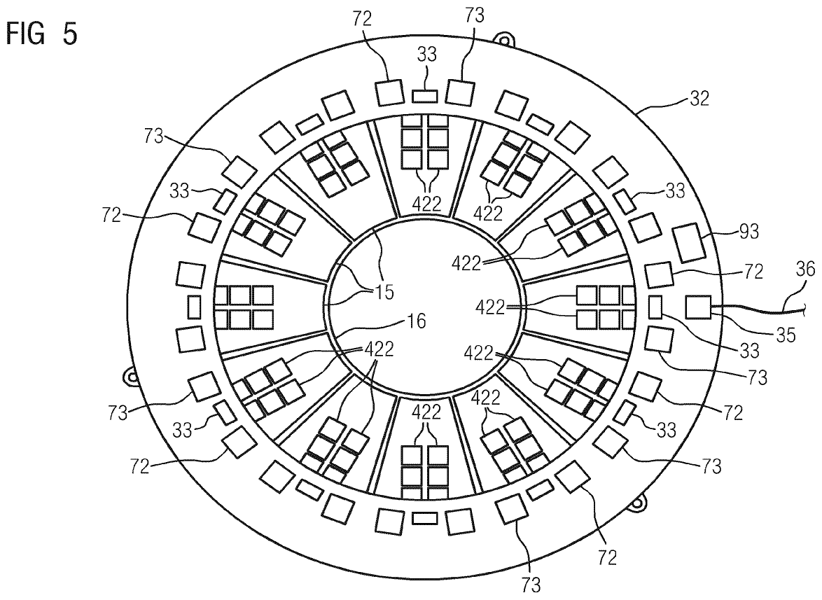

FIG. 5 shows the same configuration in a front view. In FIG. 5, it can be seen that the circuit boards 15 embody an annular structure and that the connecting PCB 32 is annular. According to FIG. 5, twelve circuit boards 15 are arranged on the front side of the cooling plate 16; if the cooling plates 16 are equipped on both sides and two cooling plates are used as shown in FIG. 4, the electric motor 10 therefore comprises 48 circuit boards 15, which are connected to a control PCB by means of four connecting PCBs 32. Only four cable connections 36 are required for this connection. In the front view of FIG. 5, only the front side of a cooling plate 16 and only one connecting PCB 32 are shown; all other elements are hidden.

The figures show, in simplified form, individual spring contacts 33 and sockets 34. In each case, however, several actual signal lines can also be implied in each case. The sockets 34 can thus actually be multipoint sockets and the spring contacts 33 corresponding multipoint connectors. Furthermore, it is insignificant which elements carry sockets 34 or spring contacts 33, as these are interchangeable.

In this example of an annular connecting PCB 32 according to FIGS. 4 and 5, all circuit boards 15 of an annular structure are thus connected to the respective connecting PCB 32 and, via the same, to the controller. In this example, for each of the connected circuit boards 15 the connecting PCB 32 has a gate driver circuit 72 and a local control chip 73. These are supplied by a multiplexer 93 with the signals which are received via the cable connection 36. Furthermore, the connecting PCB 32 has electrical connections between the elements, which connections are however not shown for reasons of clarity.

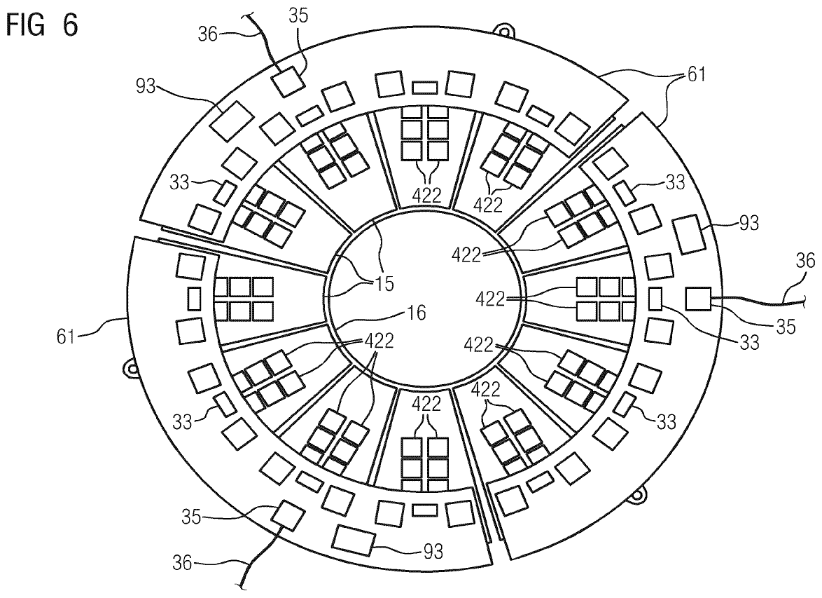

FIG. 6 shows a front view of an alternative example embodiment. Here, too, as in FIG. 5, the circuit boards 15 embody an annular structure. In contrast to FIG. 5, however, the connecting PCB is subdivided here into three ring-sector-shaped connecting PCBs 61. Each of the ring-sector-shaped connecting PCBs 61 comprises a socket 35 for a cable connection 36 to the controller and a multiplexer 93 for distributing the incoming signals. Otherwise, the ring-sector-shaped connecting PCBs 61 comprise those gate driver circuits 72 and local control chips 73 which are assigned to the circuit boards 15 connected in each case. The ring-sector-shaped connecting PCBs 61 have in each case a central angle of slightly less than 120°, in other words constitute in each case approximately one third of a circle. In this way, through the combination of three of the ring-sector-shaped connecting PCBs 61, all circuit boards 15 of the annular structure are once again connected to the controller. In addition to the example shown, the ring-sector-shaped connecting PCBs 61 could also be embodied with central angles of 180° or 90°, as a result of which the circuit boards 15 would then be contacted by means of two or four of the connecting PCBs 61.

With three ring-sector-shaped connecting PCBs 61 having a separate cable connection 36 in each case and two cooling plates equipped on both sides, there is a total of 12 cable connections 36 between the connecting PCBs 61 and the controller.

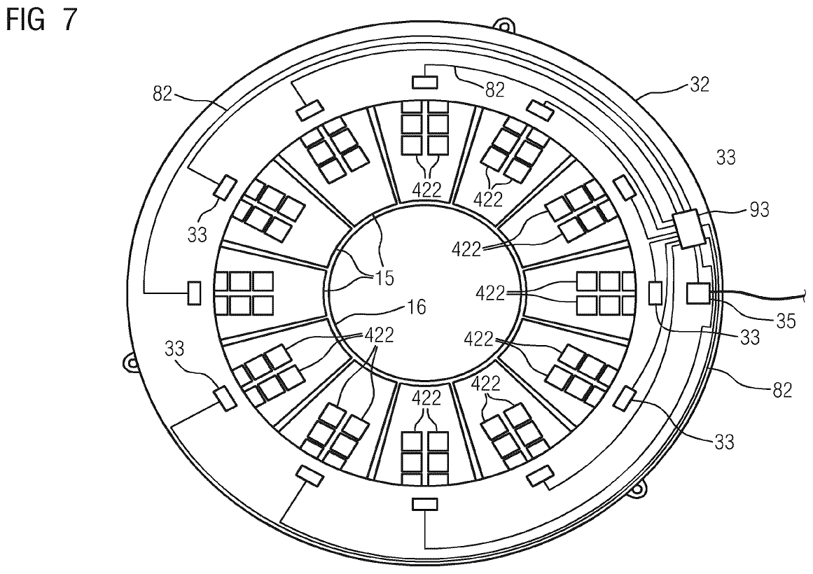

A further possible embodiment is shown in FIG. 7. The connecting PCB 75 is annular but now, in contrast to the preceding examples, does not contain the gate driver circuits 72 and local control chips 73 but instead only the socket 35, the multiplexer 93 and the spring contacts 33 to the circuit boards 15. In addition, the connecting PCB 75 can also have further electronic components for signal preparation, signal processing and communication purposes. The spring contacts 33 are connected via signal lines 82 to the multiplexer 93. The signal lines are shown as single lines for reasons of clarity but each individual one can also comprise several separate electrical connections. The connecting PCB 75 therefore serves as a signal distributor. In this embodiment, the gate driver circuits 72 and local control chips 73 are arranged on the circuit boards 15 (not shown in FIG. 7).

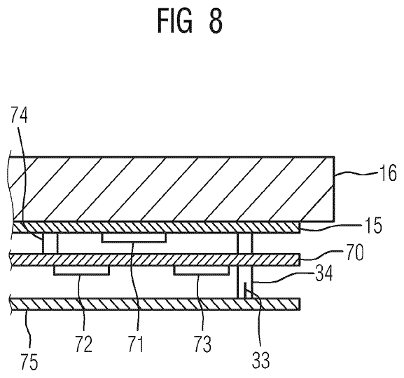

In addition to the possibility of plugging the connecting PCBs 75 directly onto those circuit boards 15 which carry the end stages, there is also a further embodiment, which is shown in FIG. 8 in a sectional view. Here, the circuit board 15 arranged on a cooling plate 16 carries an end stage of the inverter, shown in simplified form as a power semiconductor switch 71. A driver PCB 70 carries the gate driver circuit 72 and a local control chip 73. Plug-in connectors 74 transmit the signals between the circuit board 15 and the driver PCB 70. In this embodiment, the spring contact 33 is arranged on the driver PCB 70. In this embodiment, the connecting PCB 75 is therefore plugged onto the driver PCB 70, as shown.

### REFERENCE CHARACTERS

9 Motor axis
10 Electric motor
11 Stator
12 Conductor bars
13 End face
14 Rear side
15 PCB
16 Cooling plate
17 Lug
18 Connecting element
32, 61, 75 Connecting PCB
33 Spring contact
34, 35 Socket
36 Cable connection
61 Ring-sector-shaped connecting PCB
70 Driver PCB
71 Power semiconductor chip
72 Gate driver circuit
73 Local control chip
82 Signal line
93 Multiplexer
421 Contact points
422 Semiconductor switch

What is claimed is:

1. An electric motor:
a stator having a plurality of field conductor bars;
an inverter having parallel power components for each of the field conductor bars for the actuation thereof, wherein the inverter comprises a controller to generate actuation signals for the power components;
wherein
end stages of the inverter are arranged on a plurality of circuit boards;
wherein the circuit boards are arranged to form one or several circular or annular structures;
at least one plug-in connector arranged on each of the circuit boards to contact the end stages; and
a connecting PCB plugged onto the plug-in connectors of at least two of the circuit boards of one of the circular or annular structures.

2. The electric motor as claimed in claim 1, wherein the connecting is plugged onto the plug-in connectors of all circuit boards in one circular or annular structure.

3. The electric motor as claimed in claim 1, wherein the connecting PCB is annular or ring-sector-shaped.

4. The electric motor as claimed in claim 1, wherein:
the circuit boards create two or more circular or annular structures; and
for each of the circular or annular structures a connecting PCB is plugged onto the plug-in connectors of at least two circuit boards of each of the circular or annular structures.

5. The electric motor as claimed in claim 4, wherein the circular or annular structures are arranged parallel to one another and offset axially with respect to one another such that their center points lie on a common central axis.

6. The electric motor as claimed in claim 5, wherein the axis of the circular or annular structures corresponds to the motor axis.

7. The electric motor as claimed in claim 3, wherein the circular or annular structures have matching diameters.

8. The electric motor as claimed in claim 1, wherein the connecting PCB is arranged parallel to the plugged-on circular or annular structure.

9. The electric motor as claimed in claim 1, wherein the connecting PCB comprises gate driver circuits for the end stages of the plugged-on circular or annular structure.

10. The electric motor as claimed in claim 1, wherein the connecting PCB comprises a multiplexer embodied to conduct a control signal arriving from the controller to one of several signal lines in such a manner that said control signal is conducted to the power component to which the control signal applies.

11. The electric motor as claimed in claim 1, wherein the connecting PCB comprises one or several screwed connections to the circular or annular structure.

12. The electric motor as claimed in claim 1, wherein the circuit boards are arranged on at least one cooling plate arranged such that the field conductors or current conductors electrically connected to the field conductors have an active mechanical connection with the cooling plate.

13. The electric motor as claimed in claim 1, wherein the circuit boards have a shape of a circle sector or ring sector.

14. The electric motor as claimed in claim 1, wherein the motor actuates the field conductors with at least 6 phases.

15. The electric motor as claimed in claim 1, wherein the inverters generate an alternating voltage with an amplitude of 100 V or less.
